(19) United States
(12) Patent Application Publication
(10) Pub. No.: US 2021/0042827 A1
(43) Pub. Date: Feb. 11, 2021

(54) A System and Method for Trading Information

(71) Applicant: OSR ENTERPRISES AG, Cham (CH)

(72) Inventors: Yosef BEN-EZRA, Petah Tikva (IL); Samuel HAZAK, Holon (IL); Yaniv BEN-HAIM, Kfar Mordechai (IL); Yoni SCHIFF, Yahud (IL); Shai NISSIM, Tel Aviv (IL); Orit SHIFMAN, Petach Tikva (IL)

(21) Appl. No.: 16/766,590

(22) PCT Filed: Aug. 17, 2017
(86) PCT No.: PCT/IL2017/050913

§ 371 Date: May 22, 2020

(51) Int. Cl. G06Q 40/04; G06Q 30/06; G06Q 50/26; G06F 16/2458; G06F 16/23; G06F 16/28; G07C 5/00; H04L 29/08; H04L 29/06

(52) U.S. Cl. CPC G06Q 40/04; G06Q 30/0611; G06Q 50/265; G06F 16/2465; G06F 16/2379; B60R 16/0231; G07C 5/008; H04L 67/10; H04L 67/42; G06F 2216/03; G06F 16/285

(57) ABSTRACT

A car computer, a vehicle, a system and a method, the method comprising: receiving a request and response from a provider, a consumer or a trader to trade information; match the request and response to obtain an information trading deal; and providing details of the information trading deal to a computing platform adapted to be installed within a vehicle, the at least one computing platform configured to manage a blockchain comprising a block associated with the information trading deal.

### TECHNICAL FIELD

The present disclosure relates to trading information in general, and to a system and method for trading and maintaining the integrity of information trading in particular.

### BACKGROUND

In recent years, larger and larger amounts of data are required and utilized by systems related to almost any aspect of the life of people in the developed and developing world.

Such data includes personal data of people such as demographic or personal details, images, video audio, browsing history and habits, visited locations, social and professional connections and activities, or the like. Such data may be utilized in association with the specific person, for example for suggesting or tailoring content, products, services, or other offers to the person. The personal data may also be used in a wider context, for example in the development or promotion of products or services, or the like.

Further data includes content captured by capture devices, such as images, video, audio, any type of sensor, or the like, which may be used for enhancing knowledge about the environment, training artificial intelligence systems, products or services, or the like.

### BRIEF SUMMARY

One exemplary embodiment of the disclosed subject matter is a vehicle computer, comprising: a server communication module for communicating with a server and receiving at least one deal; and a blockchain mining module for maintaining a block chain and adding a block based on the at least one deal.

Another exemplary embodiment of the disclosed subject matter is a vehicle comprising: one or more information sources selected from the group consisting of: a microphone; a camera; a CANBUS interface module; an environmental sensor; a personal data collector; and a human physical data collector; a data aggregation and fusion module for aggregating and fusing the data received from the at least one information source; a data categorization and organization module for categorizing the data; and vehicle storage for storing the data, wherein the data is to be provided as part of a deal, wherein the deal is maintained in a block chain.

Yet another exemplary embodiment of the disclosed subject matter is a system for trading information, comprising: a server computing platform configured for: interacting with one or more client computing platforms and receiving a request or an offer for information trading; matching the request and the offer for information trading, thereby forming an information trading deal between an information provider and an information consumer; and one or more second computing platforms adapted to be installed within a vehicle, each second computing platform configured to manage a block chain, in which a block is associated with the information trading deal. Within the system, at least one of the information trading deal optionally relates to information gathered by a source installed on the vehicle or on another vehicle. Within the system, the information optionally comprises images, video or audio, wherein the sensor is a capture device corresponding to the sensory information, and wherein the information is collected over a period of time in areas which are at least a predetermined distance apart. Within the system, the information optionally comprises measurements related to the environment. Within the system, the information optionally comprises personal data or physical human measurements. Within the system, the information is optionally aggregated and categorized. Within the system, the client computing platform optionally displays a dashboard of outstanding requests to buy or sell information. Within the system, at least one of the information trading deals optionally relates to personal information related to a driver of the vehicle or to usage parameters the vehicle. Within the system, at least one of the information trading deal optionally relates to future provisioning of the information.

Yet another exemplary embodiment of the disclosed subject matter is a method for trading information, comprising: receiving a request and response from a provider, a consumer or a trader to trade information; match the request and response to obtain an information trading deal; and providing details of the information trading deal to a computing platform adapted to be installed within a vehicle, the at least one computing platform configured to manage a block chain comprising a block associated with the information trading deal. The method can further comprise matching terms for the information trading deal. Within the method, one or more of the information trading deal optionally relate to sensory information gathered by a sensor installed on the vehicle or on another vehicle. Within the method, the sensory information optionally comprises images, video or audio, and wherein the sensor is a capture device corresponding to the sensory information and wherein the images, video or audio are to be captured over a period of time in areas which are at least a predetermined distance apart. Within the method, the sensory information optionally comprises measurements related to the environment. Within the method, the measurements are optionally to be taken over a period of time in areas which are at least a predetermined distance apart. Within the method, the information trading deal optionally relates to information of a driver of a vehicle. Within the method, the information trading deal optionally relates to usage parameters of a vehicle. Within the method, the information trading deal optionally relates to future provisioning of the information.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic block diagram of the entities and relationships in a system for trading information, in accordance with the disclosure;

FIG. 2 is a schematic flowchart of a method for trading information, in accordance with some embodiments of the disclosure;

FIG. 3 is a schematic block diagram of modules in a car computer for collecting information, in accordance with some embodiments of the disclosure; and

FIG. 4 shows an exemplary display of a data exchange dashboard, in accordance with some embodiments of the disclosure.

### DETAILED DESCRIPTION

Developers of current and future systems, and in particular artificial intelligence systems, need larger and larger amounts of data in order to improve their models and make the systems provide functionality which is equal to or better than human behavior.

An important field in which large amounts of data are required is the automotive ecosystem.

One type of required data relates to videos captured from cars moving in various areas and various driving conditions and situations. Such footage can be used for developing products or aspects of autonomous driving, which need to learn how to respond to all kinds of conditions.

Further required data relates to personal details and data, for example of drivers. For example, monitoring data of vital signs of a driver can be used for assessing the driver's state, which can be used for learning drivers' reactions, and enhancing the behavior of autonomous systems,

Yet further data may relate to the vehicle parameters as those change during driving, such as the momentary velocity, acceleration, gas or fuel consumption, engine temperature, brakes usage, RPM, or others.

Yet further data relates to parameters of the environment in which the vehicle is moving, including for example temperature, humidity, air pollution, barometric pressure, or the like.

It will be appreciated that the types of data mentioned above are exemplary only and relate to the automotive field. However, large amounts of data of various fields and types may constantly or temporarily be required, such as shopping habits, restaurant visiting, polling results, footage from disaster areas, school ratings, or the like.

On the other hand, many people have or can obtain required information, but are unable to monetize it. For example, a person planning a road trip across a continent can supply an autonomous car developer many hours of valuable road video with minimal to no effort. The data is valuable since it is highly dispersed and thus represents a wide area. In addition, such data does not create a bias in the database as would video taken by a person who commutes along the same road every day. Additionally or alternatively, the driver can provide measurements of his or her vital signs or actions taken during the driving, as well as data from the car systems.

However, most people in this situation do not know how to trade such information.

On the other hand, companies may be striving for this kind of information, but do not have a way of obtaining it from sources and have to generate it by sending out cars to be driven for this purpose only.

The same is true for other fields as well: for example, a TV network desperate for footage from a remote and isolated disaster area may not know about a person in the area who has or can take, and is willing to sell such footage.

Thus, one technical problem addressed by the disclosure is the need to trade information, such that data providers, data consumers, or other traders can agree on transactions, including the type of data to be delivered, delivery terms and payment terms.

Blockchain is a technology employing a distributed database for maintaining a continuously growing list of records, called blocks, each containing a timestamp and a link to a previous block. A blockchain is typically managed by a peer-to-peer network collectively adhering to a protocol for validating new blocks. By design, blockchains are inherently resistant to modification of the data, since once recorded, the data in any given block cannot be altered retroactively without the alteration of all subsequent blocks and a collusion of the network majority. Functionally, a blockchain can serve as an open, distributed ledger that records transactions between two parties in a verifiable and permanent manner.

Blockchains are thus used for ensuring integrity and anonymity of deals. Blockchains are used extensively but not only for bitcoin trading.

One technical solution relates to a system and method providing a data exchange, analogous to a stock exchange, in which entities such as people or organizations can offer to sell, offer to buy or otherwise trade information. The system can be implemented as a server-client system, such as an electronic billboard, to which entities can post requests to sell or buy information, or can respond to such requests. It will be appreciated that a request can precede a response, such that the data will be obtained by the provider following the request.

The requests and responses can relate to existing data, or to future data, such as an offer to sell videos to be taken during a planned trip, such that the provider undertakes an obligation to provide the data in due time.

The reward for the data, as well as the other terms of the deal, can be part of the request, part of the response, or otherwise agreed between the parties.

In order to keep track of the transactions, a blockchain can be used, such that deals cannot be denied and their integrity is maintained.

The current disclosure relates to “car” and “vehicle” interchangeably, and is intended to cover any motorized vehicle. Another technical solution relates to maintaining the blockchain by car computers. Current blockchains are maintained by computers whose owners are rewarded for the usage of their computing resources. However, using the computing power of car computers can be rewarded by the user receiving the car computer and enjoying its other benefits, such as efficient and secure operation of the car, receiving updates, connection to the internet and others.

The disclosed method and apparatus can be used for trading data of various sources and types. In particular, such data may include but is not limited to existing or future video or audio footage captured while a car is driven in various areas, driver details, behavior and vital signs, car details and operational parameters, images or footage of various events, such as games, shows, disasters, or private events, browsing and searching history, social networking, shopping and shopping habits, or the like. The data may be used by entities such as mapping institutes wishing to map an environment, insurance companies offering insurance to drivers, autonomous car providers that need road data for training the driving modules (once the footage has been labeled by competent people or systems), or others.

In some examples, the data may be aggregated. For example, a specific search for a term in the internet may not be very interesting, but a volume of users making the same search can indicate that the subject is important or trendy, and may be investigated by a relevant authority or institute.

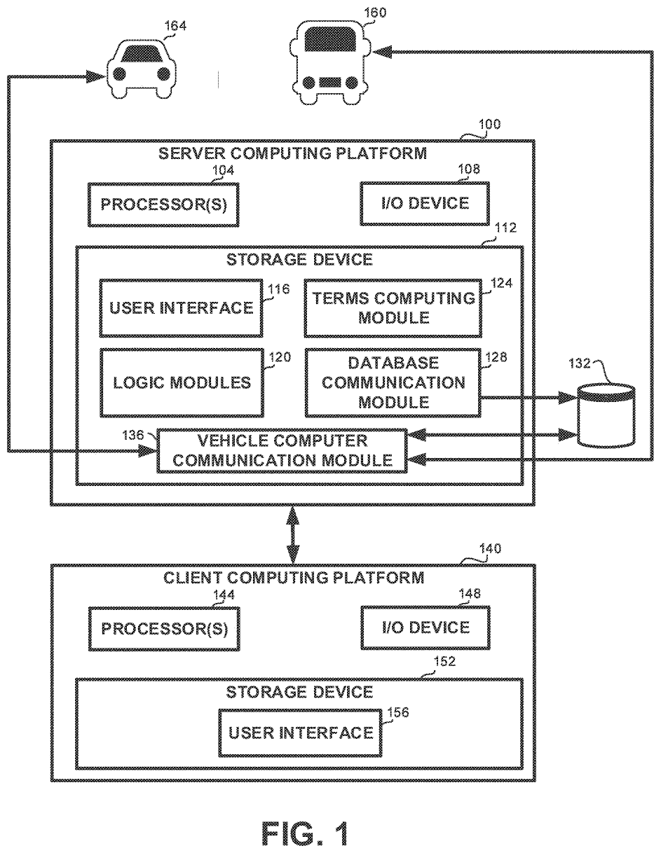

Referring now to FIG. 1, showing a schematic block diagram of the entities and relationships in a system for trading information, in accordance with the disclosure.

The system comprises one or more computing platforms 100. In some embodiments, computing platform 100 may be a server, and may provide services to one or more client computing platforms 140. In other embodiments, computing platforms 100 and 140 may be implemented on the same computing device.

Computing platform 100 may be accessed by a multiplicity of client computing platforms 140 via any communication channel, such as the Internet, a Wide Area Network, a Local Area Network, intranet, or the like.

Computing platform 100 may comprise a processor 104 which may be one or more Central Processing Unit (CPU), a microprocessor, an electronic circuit, an Integrated Circuit (IC) or the like. Processor 104 may be configured to provide the required functionality, for example by loading to memory and activating the modules stored on storage device 112 detailed below.

It will be appreciated that computing platform 100 may be implemented as one or more computing platforms which may be in communication with one another. It will also be appreciated that processor 104 may be implemented as one or more processors, whether located on the same platform or not.

Computing platform 100 may also comprise Input/Output (I/O) device 108 such as a display, a pointing device, a keyboard, a touch screen, or the like. I/O device 108 may be utilized to receive input from and provide output to a user such as but not limited to an administrator.

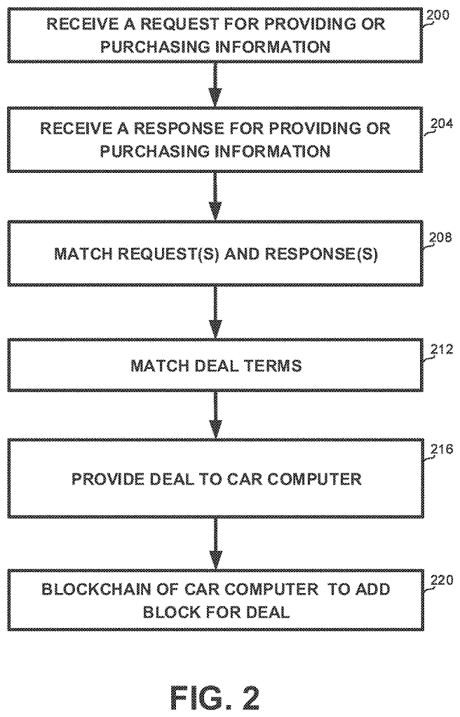

Computing platform 100 may also comprise a storage device 112, such as a hard disk drive, a Flash disk, a Random Access Memory (RAM), a memory chip, or the like. In some exemplary embodiments, storage device 112 may retain program code operative to cause processor 104 to perform acts associated with any of the modules listed below or steps of the method of FIG. 2 below. The program code may comprise one or more executable units, such as functions, libraries, standalone programs or the like, adapted to execute instructions as detailed below.

Storage device 112 can comprise user interface 116, to be used for example by an administrator for entering data, arranging data categories, enabling or disabling options, or the like.

Storage device 112 can comprise one or more logic modules 120 for matching requests and responses, and handling other issues, such as user registration, security, credit, maintaining user reliability scores, or the like.

Storage device 112 can comprise terms computing module 124 for computing delivery, payment, or other terms for a request-response pair. The terms may be agreed between the parties and approved by terms computing module 124, but may also be computed or complemented by terms computing module 124.

Storage device 112 can comprise database communication module 128 for communicating with one or more vehicle storage such as databases 132.

Database 132 can comprise data such as user details, past and present requests and responses, agreed terms, security details, or the like.

Database communication module 128 can be used for updating data in database 132, retrieving data from database 132. The data nay include data received from any one or more client computing platforms 140 or data originating from server computing platform 100.

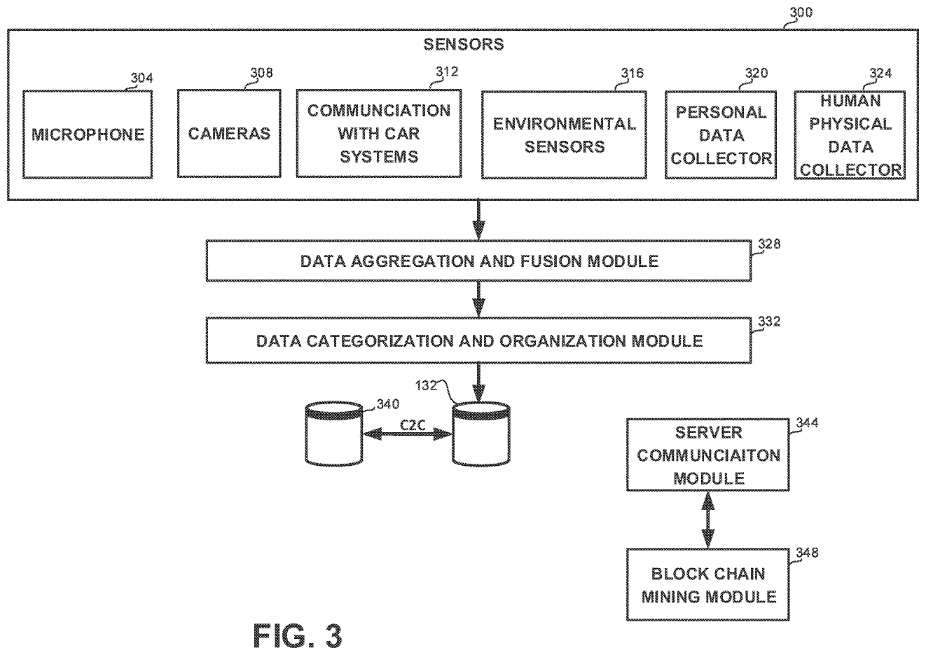

Storage device 112 can comprise car communication module 136 for communicating with one or more cars such as cars 160 and 164. Each of cars 160 and 164 comprises a car computer detailed in association with FIG. 3 below, equipped at least with a processor and wireless communication module, wherein all car computers maintain copies of the same ledger, related to data trading.

Car communication module 136 can thus transmit one or more request-response pairs to cars 160 and 164 which can add corresponding one or more blocks to the blockchain.

Server computing platform 100 can communicate with one or more client computing platforms 140. Client computing platform 140 can comprise a processor 144, I/O device 148, and storage device 152 analogous to processor 104, I/O device 108 and storage device 112 of server computing platform 100 described above.

Storage device 152 of client computing platform 140 can comprise user interface 156, using which a user can enter a request to purchase data, a request to offer data a response to an existing offering to purchase data or to offer data, a request to trade in information as a third party, e.g. neither a data owner nor as a data user, or the like.

In some embodiments, any one or more of user interface 116, logic module 120, terms computing module 124, database communication module 128 and car computer more client computing platforms 136 can be provided as a web application, used via a browser by client computing platform 140.

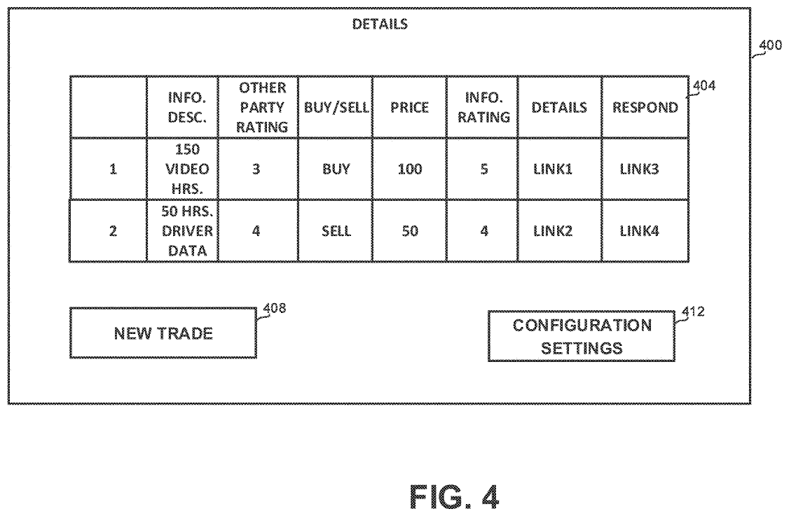

Alternatively, user interface 156 can be implemented as an executable, library, or the like. FIG. 4 below demonstrates an exemplary dashboard represented by user interface 156.

It will be appreciated that multiple server computing platforms 100 and multiple client computing platforms 140 can exist, maintaining a multiplicity of databases 132. It will also be appreciated that each car such as cars 160 or 164 can be associated with one or more server computing platforms 100, and can maintain one or more ledgers wherein each ledger comprises blocks added in accordance with information received from one or more server computing platforms 100.

Car computers of cars 160 and 164 are used for mining the blockchain while adding blocks, thus maintaining the integrity of the data trades. It will be appreciated, however, that cars 160 or 164 and their drivers can, but do not have to participate in capturing video footage, providing driver or car parameters or any other data as part of participating in a data trade.

Referring now to FIG. 2, showing a schematic flowchart of a method for trading information, in accordance with the disclosure.

At step 200, server computing platform 100 can receive a request for providing or purchasing information from a client computing platform 140. Database 132 can be updated with the request details.

At step 204, server computing platform 100 can receive a response for an outstanding request for providing or purchasing information from a client computing platform 140. Database 132 can be updated with the response details.

In some examples, the request or the response may not be a one-time event, but rather relate to a repeating request or response, for example a request to purchase 150 monthly hours of video taken from a car in a specific area. Such request and a corresponding response may be translated to a multiplicity of deals.

On step 208, logic modules 120 can match one or more requests received on step 200 with one or more responses received on step 204 to obtain a deal.

On step 212, which can also be performed as part of step 208, terms computing module 124 can computer the terms of the deal matched on step 208

On step 216, car computer communication module 136 can provide the deal to one or more car computers associated with the respective server.

On step 220, the blockchain of the car computer adds a block representing the deal to the ledger.

It will be appreciated that as with any blockchain, multiple car computers can attempt to add the block, wherein only one computer gets to complete the task, and all ledgers are updated accordingly.

Referring now to FIG. 3, showing a schematic block diagram of modules for information collection in a car and in a car computer, in accordance with some embodiments of the disclosure. It will be appreciated that the displayed components may not relate to blockchain mining, and can be installed in any car whose owner wishes to collect information. In some examples, data collected by sensors installed on other cars may also be received.

The car comprises various sensors 300, such as but not limited to:

One or more microphones 304, located internally or externally to the car and recording audio;

One or more cameras 312 located internally or externally to the car and taking images or videos of the car, the driver, the passengers, or the near or far environment, such as the road, roadside, or the like;

Communication with car systems 312 for receiving sensory information, indications or data from the car systems, such as cycles per minute, brakes state, engine temperature, whether a control such as a window control has been activated, multimedia usage, or the like. The indications or data can be received via a bus communication system, such as CANBUS;

Environmental sensors 316 for receiving sensory data of the environment, such as temperature, humidity, pollution level, or the like;

Personal data collector for receiving data related to the driver, such as e-mails, calendar events, shopping history and habits, social connections, or the like; and

Physical human data collector, connected for example to systems collecting vital signs of the driver such as heartbeat, pulse, temperature, or the like.

It will be appreciated that any different or other sensors can be used for collecting data which can be traded.

Data from all such sensors may be aggregated and fused by data aggregation and fusion module 328. Exemplary fusion is disclosed in PCT application no. PCT/IL2017/050611 filed Jun. 1, 2017, titled “A System and Method for Fusing Information of a Captured Environment” assigned to the same assigned as the current application.

The data may then be categorized and organized by data categorization and organization module 332. The data may be categorized into existing categories of data that are known to be sellable.

The data may then be stored in vehicle storage 336, which may be in communication with one or more storage devices 340 of another vehicle, via a Car-to-Car (C2C) communication channel, or with one or more server storage devices 132.

One or more car computers can comprise server communication module 344 for communicating with server computing platform 100 and receiving deals, and blockchain mining module 348 for adding blocks corresponding to the received deals. Server communication module 344 and blockchain mining module 344 can be installed and executed whether or not sensors 300, data aggregation and fusion module 328 and data categorization and organization module 332 are installed within the car, since blockchain mining module is installed for utilizing the computing resources of the car computer.

Referring now to FIG. 4, showing an exemplary display of a data exchange dashboard 400. Dashboard 400 can be displayed to a user seeking to trade information as part of user interface 156.

Dashboard 400 can comprise configuration setting control 412, for changing the configuration, for example the graphical configuration, parameters, the preferences such as types of deals to be displayed, the information to be displayed for each deal, or the like.

Dashboard 400 can comprise a new trade control 408, for creating a new request, such as an offer to sell information, an offer to buy information, or the like.

Dashboard 400 can comprise a table 404, comprising a row for each outstanding request. The dashboard can show any one or more of the following details, or additional ones:

A short description of the data offered for sell or buy;

A rating of the other party, for example whether it is a reliable party, whether it is known to be against the user's interests such as a competitor, a hostile organization or person, or the like. It will be appreciated that each user, including the current user can have a rating. The rating may be personal, for example of a user, of a group, or the like. The rating may be as determined for example by partners of past trades, and related for example to the reliability, term compliance, or the like. The rating of the other party can be personalized to the current user. For example, a business competitor can have low rating for a current user and high rating for a non-competing party;

Whether the offer is to buy or sell data;

The rating of the info, for example how much the requestor is eager to make the deal;

Additional details for example detailing the information description, including for example the price and payment terms; and a link to responding to the request.

It will be appreciated that dashboard 400 is exemplary only, and other display options can be used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). Each block may be implemented as a multiplicity of components, while a number of blocks may be implemented as one component. Even further, some components may be located externally to the car, for example some processing may be performed by a remote server being in computer communication with a processing unit within the vehicle. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A vehicle computer, comprising:
a server communication module for communicating with a server and receiving at least one deal; and
a blockchain mining module for maintaining a blockchain and adding a block based on the at least one deal.

2. A vehicle comprising:
at least one information source selected from the group consisting of: a microphone; a camera; a CANBUS interface module; an environmental sensor; a personal data collector; and a human physical data collector;
a data aggregation and fusion module for aggregating and fusing the data received from the at least one information source;
a data categorization and organization module for categorizing the data; and
vehicle storage for storing the data,
wherein the data is to be provided as part of a deal, wherein the deal is maintained in a blockchain.

3. A system for trading information, comprising:
a server computing platform configured for:
interacting with at least one client computing platform and receiving a request or an offer for information trading;
matching the request and the offer for information trading, thereby forming an information trading deal between an information provider and an information consumer; and
at least one second computing platform adapted to be installed within a vehicle, the at least one second computing platform configured to manage a blockchain, in which a block is associated with the information trading deal.

4. The system of claim 2, wherein at least one of the information trading deal relates to information gathered by a source installed on the vehicle or on another vehicle.

5. The system of claim 2, wherein the information comprises images, video or audio, wherein the sensor is a capture device corresponding to the sensory information, and wherein the information is collected over a period of time in areas which are at least a predetermined distance apart.

6. The system of claim 2, wherein the information comprises measurements related to the environment.

7. The system of claim 2, wherein the information comprises personal data or physical human measurements.

8. The system of claim 2, wherein the information is aggregated and categorized.

9. The system of claim 2, wherein the client computing platform displays a dashboard of outstanding requests to buy or sell information.

10. The system of claim 2, wherein at least one of the information trading deals relates to personal information related to a driver of the vehicle or to usage parameters the vehicle.

11. The system of claim 2, wherein at least one of the information trading deal relates to future provisioning of the information.

12. A method for trading information, comprising:
receiving a request and response from a provider, a consumer or a trader to trade information;
matching the request and response to obtain an information trading deal; and
providing details of the information trading deal to a computing platform adapted to be installed within a vehicle, the at least one computing platform configured to manage a blockchain comprising a block associated with the information trading deal.

13. The method of claim 12, further comprising matching terms for the information trading deal.

14. The method of claim 12, wherein at least one of the information trading deal relates to sensory information gathered by a sensor installed on the vehicle or on another vehicle.

15. The method of claim 12 wherein the sensory information comprises images, video or audio, and wherein the sensor is a capture device corresponding to the sensory information and wherein the images, video or audio are to be captured over a period of time in areas which are at least a predetermined distance apart.

16. The method of claim 12 wherein the sensory information comprises measurements related to the environment.

17. The method of claim 16 wherein the measurements are to be taken over a period of time in areas which are at least a predetermined distance apart.

18. The method of claim 12, wherein the information trading deal relates to information of a driver of a vehicle.

19. The method of claim 10, wherein the information trading deal relates to usage parameters of a vehicle.

20. The method of claim 12, wherein the information trading deal relates to future provisioning of the information.
